(19) United States
(12) Patent Application Publication
(10) Pub. No.: US 2019/0034396 A1
(43) Pub. Date: Jan. 31, 2019

(54) NON-TRANSITORY COMPUTER READABLE MEDIUM AND ARTICLE EDITING SUPPORT APPARATUS

(71) Applicant: FUJI XEROX CO., LTD., Tokyo (JP)

(72) Inventor: Yuhei SHIMADA, Kanagawa (JP)

(73) Assignee: FUJI XEROX CO., LTD., Tokyo (JP)

(21) Appl. No.: 15/947,259

(22) Filed: Apr. 6, 2018

(30) Foreign Application Priority Data
Jul. 27, 2017 (JP) 2017-145788

(51) Int. Cl. G06F 17/24; G06F 17/22

(52) U.S. Cl. CPC G06F 17/24; G06F 17/2235; G06F 17/2211

(57) ABSTRACT

A non-transitory computer readable medium stores a program causing a computer to execute a process. The process includes determining a source article that includes a link to an edited article, the edited article being an article to be edited, and controlling notification, the controlling of notification including controlling, in accordance with the importance level of the edited article for the source article, the mode in which a notification about editing performed on the edited article is provided to a user associated with the source article.

### CROSS-REFERENCE TO RELATED APPLICATIONS

This application is based on and claims priority under 35 USC 119 from Japanese Patent Application No. 2017-145788 filed Jul. 27, 2017.

### BACKGROUND

### Technical Field

The present invention relates to a non-transitory computer readable medium, and an article editing support apparatus.

### SUMMARY

According to an aspect of the present invention, there is provided a non-transitory computer readable medium storing a program causing a computer to execute a process, the process including determining a source article that includes a link to an edited article, the edited article being an article subjected to editing, and controlling notification, the controlling of notification including controlling, in accordance with the importance level of the edited article for the source article, the mode in which a notification about editing performed on the edited article is provided to a user associated with the source article.

### BRIEF DESCRIPTION OF THE DRAWINGS

Exemplary embodiment of the present invention will be described in detail based on the following figures, wherein:

FIG. 1 illustrates an exemplary functional configuration of an article editing support apparatus;

FIG. 2 illustrates exemplary data contained in an article database (DB);

FIG. 3 illustrates exemplary data contained in an author DB;

FIG. 4 illustrates exemplary data contained in a notification history DB;

FIG. 5 illustrates an exemplary procedure of processing performed by an edit processor;

FIG. 6 illustrates an exemplary procedure of processing performed by an edit notification unit;

FIG. 7 illustrates an exemplary importance level calculation procedure performed by a notification controller;

FIG. 8 illustrates another exemplary importance level calculation procedure performed by a notification controller;

FIG. 9 illustrates an exemplary case in which the procedure illustrated in FIG. 8 is applied to specific articles;

FIG. 10 illustrates the major portion of a procedure of processing performed by an edit notification unit according to a first modification;

FIG. 11 illustrates the major portion of a procedure of processing performed by an edit notification unit according to a second modification;

FIG. 12 illustrates the major portion of a procedure of processing performed by an edit notification unit according to a third modification;

FIG. 13 illustrates an exemplary functional configuration of an article editing support apparatus according to a fourth modification;

FIG. 14 illustrates the major portion of a procedure of processing performed by an edit processor according to a fourth modification; and

FIG. 15 illustrates another exemplary importance level calculation procedure performed by a notification controller.

### DETAILED DESCRIPTION

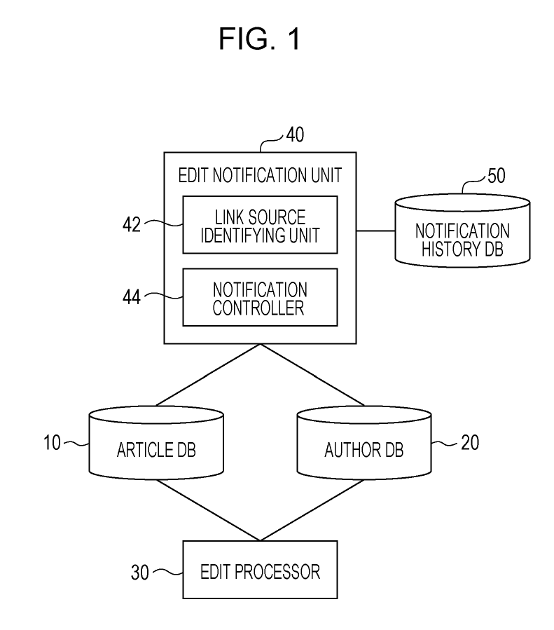

FIG. 1 illustrates the configuration of an article editing support apparatus according to an exemplary embodiment of the present invention. The article editing support apparatus supports editing performed on a group of hypertext articles by multiple users. The article editing support apparatus includes an article database (DB) 10, an author DB 20, an edit processor 30, an edit notification unit 40, and a notification history DB 50. Although the following description will be directed to a case in which articles are written in the HyperText Markup Language (HTML), articles may be written in a language other than HTML that allows writing of hypertext.

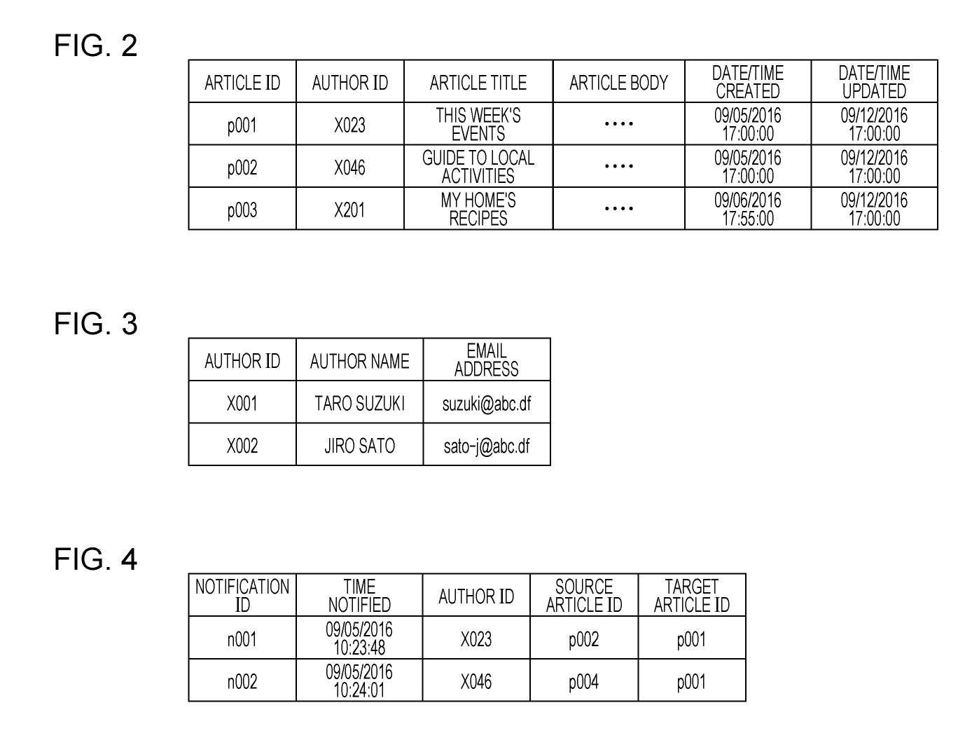

The article DB 10 is a database that stores and manages data on each individual article. FIG. 2 illustrates exemplary data on articles stored in the article DB 10. In the example illustrated in FIG. 2, data on each individual article includes items such as Article Identification Information (ID), Author ID, Article Title, Article Body, Date/time Created, and Date/time Updated. “Article ID” represents identification information for uniquely identifying the article. As an article ID, the Uniform Resource Locator (URL) of the HTML data of the article may be used. Alternatively, a URL pointing to an article may include the article ID of the article (e.g., the portion of the file name of the article's body within the URL represents article ID). “Author ID” represents identification information for uniquely identifying the author of the article. That is, the Author ID field records the user ID of the author of the article, among the user IDs of users registered in the article editing support apparatus. If there are multiple authors of the article, the Author ID field records the author IDs of the multiple authors. “Article Title” represents the title of the article, which is written in the header of the HTML data of the article by using a “title” tag. “Article Body” represents the body, that is, the “body” element of the HTML data of the article. The article body may contain a hyperlink (to be simply referred to as link hereinafter) to another article. “Date/time Created” represents the date/time when the article is updated (that is, when the article is registered into the article DB 10). “Date/time Updated” represents the date/time when the article within the article DB 10 is last updated.

The article DB 10 may have an article version control function.

The author DB 20 is a database that stores and manages data on each individual author. FIG. 3 illustrates exemplary data on authors stored in the author DB. In the example illustrated in FIG. 3, data on each individual author includes items such as Author ID, Author Name, and E-mail Address. Author ID has already been described above. “Author Name” represents the name of the author. “E-mail Address” represents the e-mail address of the author. This e-mail address is used in notifying the author when editing is performed on an article that is being linked from the article written by the author.

The edit processor 30 provides an article edit processing service to a user. The user (author) logs into the edit processor 30 of the article editing support apparatus from, for example, the user's own personal computer (PC) via a network such as an intra-office network or the Internet. The edit processor 30 provides an environment for creating and editing articles to the user's PC via the network. The provided environment is used by the user to perform various operations, such as creating a new article, or editing an article within the article DB 10 previously created by the user (or an article that the user is authorized to edit). When the user creates a new article and instructs the created article to be stored, the article is given an article ID from the edit processor 30, and stored into the article DB 10 together with information on items such as Author ID (see FIG. 2). If an article within the article DB 10 is edited by a user who has the authority to edit the article, and the user instructs to store the article, then the body (article title in some cases) of the article within the article DB 10 is changed to reflect the editing done, and the date/time of update is changed to the date/time when the instruction to store the article is given.

When an article within the article DB 10 is edited, the edit notification unit 40 provides notification of the edit performed to the author of a source article, which is an article linking to the article subjected to editing (to be referred to as “edited article” hereinafter). The reason to notify the author of the source article is to allow the author to check whether the contents of the source article are consistent with the post-edit contents of the edited article and, in the absence of such consistency, correct the source article in accordance with the contents of the edited article.

However, the edit notification unit 40 does not necessarily notify the author of the source article whenever an edit is made to the edited article. The edit notification unit 40 does not provide such notification if the edit made to the edited article is not important for the source article.

The edit notification unit 40 includes a link source determination unit 42 and a notification controller 44. The link source determination unit 42 determines which among articles stored in the article DB 10 is a source article that links to an edited article. The notification controller 44 controls whether to provide, for the determined source article, a notification about editing performed on the edited article. This control is performed by determining whether the edited article is important for the source article. Whether the edited article is important is determined by analyzing the relationship between the edited article and the source article that links to the edited article. Exemplary methods for this determination will be described later in detail.

The notification history DB 50 is a database that records history information on notifications previously made by the edit notification unit 40. FIG. 4 illustrates exemplary notification history data recorded in the notification history DB 50. Notification history data includes items such as Notification ID, Time Notified, Author ID, Source Article ID, and Target Article ID. Notification ID represents identification information for uniquely identifying a notification of interest. “Time Notified” represents the time when the notification is performed (e.g., transmitted). “Author ID” represents identification information for identifying the author to whom the notification is provided. “Source Article ID” represents identification information for determining a source article that links to the edited article undergoing editing related to the notification and is created by the author who is the recipient of the notification. “Target Article ID” represents identification information for identifying an edited article on which edit related to the notification has been performed. Upon providing notification of an edit made to an article to the author of a source article that links to the edited article, the notification controller 44 records information about the notification into the notification history DB 50. Although not illustrated in FIG. 4, the notification history DB 50 may record, in association with a notification ID, information indicating whether the corresponding notification is to be provided by email or on a management screen as will be described later. In another possible example, the notification history DB 50 records only notifications made by email, which is a mode of notification used for notifications of high importance level.

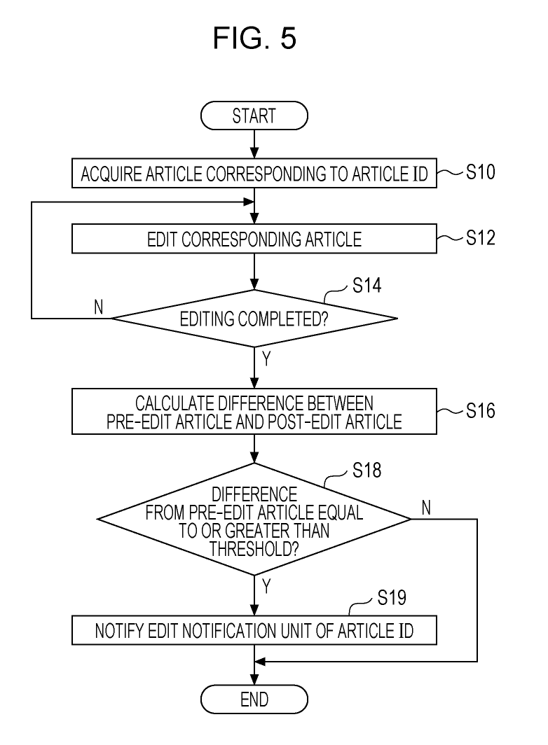

Next, an exemplary procedure of processing performed by the edit processor 30 will be described with reference to FIG. 5.

According to this procedure, when the edit processor 30 receives, from a user who has logged into the article editing support apparatus, an input of the article ID of an article that is to be edited, the edit processor 30 determines, by means of a known access right control method, whether the user has the authority to edit for the article ID. If the edit processor 30 determines that the user has the edit authority (e.g., the user is one of the authors of the article), the edit processor 30 acquires the article body (also the article title in some cases) corresponding to the article ID from the article DB 10 (S10), and provides the user (i.e., the PC being operated by the user) with screen information that serves as the environment for editing the article body. The edit processor 30 receives an edit operation (such as a change to a description) that the user has performed on the article body or other information in the editing environment (S12). Then, the edit processor 30 waits until an edit complete instruction is input from the user (S14).

When an edit complete instruction is input from the user, the edit processor 30 stores the data of the (post-edit) article retained by the editing environment into the article DB 10. Further, the edit processor 30 calculates the difference in character string between the article body or other information before editing and the article body or other information after editing (S16). The edit processor 30 then determines whether the difference (e.g., the difference in the number of characters before and after editing) is equal to or greater than a predetermined threshold (S18). If the difference is equal to or greater the threshold, the edit processor 30 notifies the edit notification unit 40 of the article ID (S19), and ends the procedure. If the edit processor 30 determines at step S18 that the difference is less than the threshold, the edit processor 30 skips S19. That is, if the difference in article content due to editing is less than the threshold, it is highly likely that the editing done is a minor edit such as correction of a typo. Thus, such an edit is removed from those edits of which the author of the source article is to be notified. Conversely, if the difference due to editing is equal to or greater the threshold, it is likely that the editing done is an important edit. Thus, the edit processor 30 informs the edit notification unit 40 of such an edit so that the edit notification unit 40 determines whether notification needs to be provided.

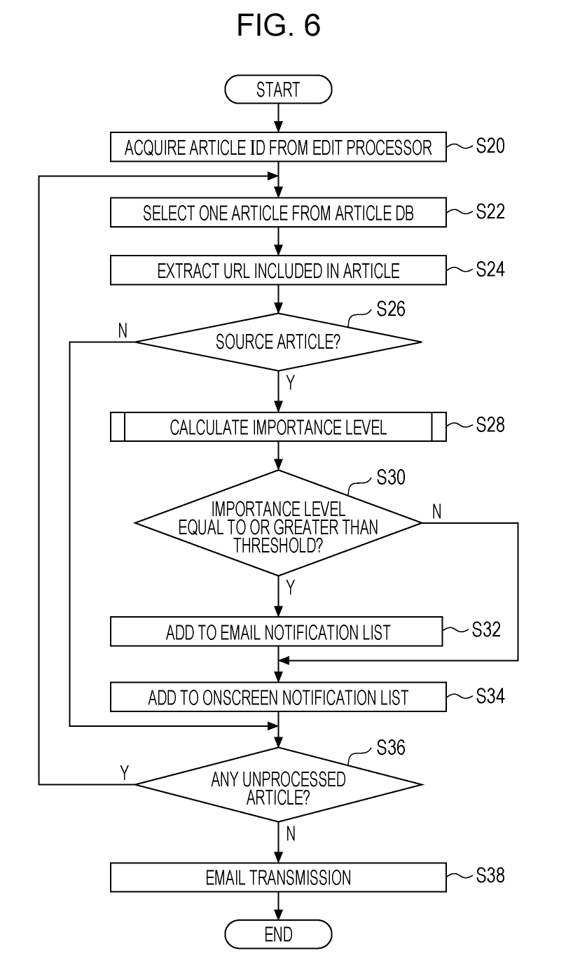

Next, an exemplary procedure of processing performed by the edit notification unit 40 will be described with reference to FIG. 6.

The procedure illustrated in FIG. 6 begins with the edit notification unit 40 receiving the article ID (the ID of an article that has undergone editing, i.e., the ID of the edited article) transmitted by the edit processor 30 at S19 (S20). The edit notification unit 40 retains the received article ID as the ID of the edited article.

Next, the edit notification unit 40 selects one article stored in the article DB 10 (S22). Then, the edit notification unit 40 performs steps S24 to S36 for the selected article.

That is, the link source determination unit 42 of the edit notification unit 40 extracts one or more link descriptions (e.g., anchor elements including an URL or other information) from within the body of the article selected at S22 (S24). The link source determination unit 42 then determines whether there is any link description among the one or more extracted link descriptions that links to the edited article (i.e., the article corresponding to the ID acquired at S20) (S26). From a different perspective, the determination at S26 is a determination of whether the article selected at S22 is the link source that links to the edited article.

If the result of determination at S26 is N (negative), that is, if the selected article is not the link source that links to the edited article, the edit notification unit 40 determines whether there is any article within the article DB 10 that has not undergone steps S24 to S36 (to be referred to as “unprocessed article” hereinafter). If there is any unprocessed article, the edit notification unit 40 returns to S22, where the edit notification unit 40 selects one unprocessed article within the article DB 10 and repeats the steps from S24 onward for the selected unprocessed article.

If the result of determination at S26 is Y (affirmative), that is, if the selected article is the link source that links to the edited article, the notification controller 44 calculates the level of importance of the edited article for the source article (S28). Several exemplary methods for calculating this importance level will be described later. Once the importance level is calculated, the notification controller 44 determines whether the importance level is equal to or greater than a predetermined threshold (S30). The threshold in this case is a value used as a cutoff to determine whether the edited article is important for the source article. Any edited article with an importance level equal to or greater the threshold is regarded as important for the source article.

If the result of determination at S30 is Y, the notification controller 44 determines, from the article DB 10, the author ID of an author corresponding to the article ID of the source article, and determines, from the author DB 20, an email address corresponding to the author ID. The notification controller 44 then adds the determined email address to an email notification list (S32). Further, the notification controller 44 adds the author ID determined at S32 to an onscreen notification list, which is a list of users to be notified upon login to the management screen (S34). The notification controller 44 manages the email notification list and the onscreen notification list in association with the ID of each edited article and information of which the user is to be notified. If the result of determination at S30 is N, the procedure proceeds to S34.

Subsequently, the notification controller 44 determines the presence of any unprocessed article within the article DB 10 (S36). If there is any unprocessed article, the notification controller 44 returns to S22 to select one unprocessed article within the article DB 10, and then repeats the steps from S24 onward for the selected unprocessed article.

If it is determined at S36 that there is no unprocessed article within the article DB 10, the notification controller 44 transmits, to each email address included in the email notification list, an email indicating that editing has been performed on the edited article (i.e., the article corresponding to the ID acquired at S20) (S38). This e-mail contains, for example, the URL of the edited article, and a message indicating that the article has been edited. Alternatively, this email may contain information such as an excerpt of the edited portion (i.e., changed portion) of the article.

In the exemplary embodiment, in addition to notification by email described above, notification that a related article has been edited is provided also on a management screen displayed upon user's login to the article editing support apparatus. For example, in addition to items such as a list of articles on which the user has access rights and a search field for such articles, the management screen includes an edit notification field for notifying that a related article has been edited. Alternatively, such an edit notification may be displayed as a piece of newly arrived information in a display field that displays newly arrived information. The onscreen notification list mentioned above presents a list of the user IDs of users for whom to display a notification that an edit has been made on the edited article, among users registered in the article editing support apparatus. For the procedure illustrated in FIG. 6, a notification by email is sent only to the authors of source articles for which the importance level is determined to be equal to or greater than a threshold, whereas a notification by the management screen is provided to the authors of all source articles irrespective of the importance level.

A notification made by the management screen tends to be not easily unrecognized by the user as this notification is displayed on the management screen together with other displayed information (e.g., an article list, or newly arrived information other than edit notifications). Further, as time passes, a notification by the management screen is removed from the notifications to be displayed (e.g., the notification ceases to be newly arrived information). Thus, if notification is provided by the management screen, there is a possibility that an edit to an article remains unrecognized by the user. By contrast, if the user is notified by email, an edit made to an article may be recognized by the user in a straightforward manner (e.g., without being mixed with other information that becomes noise). Moreover, once received, an email is not automatically erased. Therefore, such a notification by email has greater chances of being recognized by the user than a notification displayed on the management screen. For these reasons, it may be said that a notification by e-mail is easily noticeable (i.e., easily recognized by the user) relative to a notification displayed on the management screen. That is, according to the exemplary embodiment, among the authors of source articles that link to an edited article, the author of a source article for which the importance level of the edited article is high (i.e., equal to or greater than a threshold) is notified in a more easily noticeable manner than the author of a source article for which the importance level of the edited article is low (i.e., less than a threshold).

Generally speaking, a first notification mode (e-mail in the above-mentioned case), which is a mode of notification used if the importance level is equal to or greater than a threshold, is more noticeable than a second notification mode (notification by the management screen in the above-mentioned case), which is a mode of notification used if the importance level is less than the threshold. The term “noticeable” as used herein means that the notification in question is easily recognized by the user (the author of the source article) (in comparison to the second notification mode). This includes the following cases. That is, a notification is “noticeable” if, for example, one of the followings holds: (a) The mode of display of the notification itself easily draws the attention of the user, (b) The notification is stored even after once presented to the user so that the user is able to view the notification again later, and (c) Once the notification is presented to the user and then stored, the user is able to view information about the notification again easily (i.e., through a simple procedure or through a procedure familiar to the user). By contrast, when it is stated that the second notification mode is less “noticeable”, this includes, for example, one of the followings: (a) The second notification mode itself does not easily draw the attention of the user (in comparison to the first notification mode), (b) The notification is erased after once presented to the user, and the user is unable to view the notification again, and (c) Once the notification is presented to the user and then stored, it is difficult for the user to view information about the notification again in comparison to the first notification mode. Examples of cases in which it is easy to view a stored notification again include when the notification is stored in a tool familiar to the user, for example, an email tool, and when a tab or icon used to call up a list of past notifications is displayed in a conspicuous location on the editing screen on which the article is being edited (i.e., when a list of past notifications is called up by a simple one-click action on the editing screen). By contrast, examples of cases in which it is difficult to view a stored notification again include when the user has to navigate through multiple layers of menus from the editing screen in order to call up a list of past notifications.

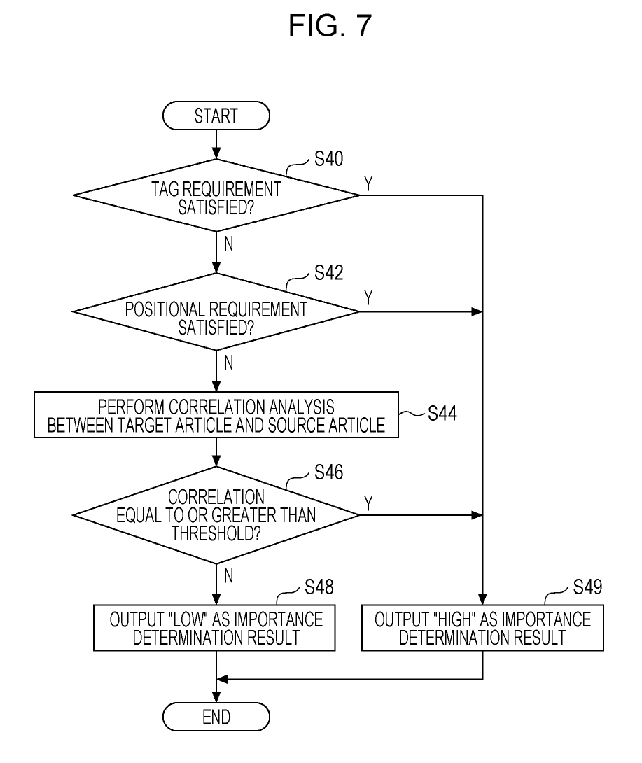

Next, an exemplary detailed procedure for step S28 of the procedure illustrated in FIG. 6 will be described with reference to FIG. 7.

The procedure illustrated in FIG. 7 calculates the level of importance of the edited article (the article corresponding to the ID acquired at S20 in FIG. 6) for the source article (the article selected at S22). According to this procedure, the notification controller 44 determines whether a link description within the source article that points to the edited article satisfies a tag requirement (S40). The tag requirement refers to a condition that the link description be enclosed by a specific tag having an emphasis function. The term “emphasis” as used herein means emphasizing characters so that the characters are displayed in a manner more noticeable than the manner in which the characters are normally displayed within a paragraph of an article. Examples of specific tags having an emphasis function include heading tags such as an “h1” tag, tags meaning emphasis such as an “em” tag or a “strong” tag, and tags having the function of emphasis such as a “b” tag (bold), an “i” tag (italic), or a “big” tag (indicating font size enlargement). If a link description (e.g., described by using an “a” tag or other tags) within the source article that points to the edited article is enclosed by one of the specific tags mentioned above, then the result of determination at S40 is Y (affirmative).

Further, the notification controller 44 determines whether a link description within the source article that points to the edited article satisfies a positional requirement (S42). The positional requirement refers to a condition that the link description be placed at a position in the source article that is easily recognized by a viewer who is viewing the article. A viewer who starts reading the source article does not necessarily read the article to the very end. Thus, it may be said that the closer a link description is positioned to the beginning of the article, the more easily the link description is recognized by the viewer. For example, at step S42, the notification controller 44 determines that a link description pointing to the edited article satisfies the positional requirement (the determination result is Y) if the link description is located higher (closer to the beginning) than a position corresponding to one-half of the total number of lines in the source article. It is to be noted that one-half is merely an exemplary value.

Further, the notification controller 44 performs a correlation analysis between the target article (i.e., the edited article) and the source article (S44). The correlation analysis is performed to obtain a numerical value representing how strongly (closely) the contents of these two articles are correlated with each other. In the correlation analysis, for example, the cosine (COS) similarity between the two articles is calculated as a value representing the correlation between the two articles. With the numbers of occurrences of individual words within the articles represented as vectors, the COS similarity is given by the dot product of those vectors divided by their magnitudes. Use of COS similarity as a value representing the correlation between the two articles is merely illustrative, and other known correlation computation methods may be employed. The notification controller 44 then determines whether the magnitude of the correlation calculated at S44 is equal to or greater than a threshold (S46).

If the determination results at S40, S42, and S46 are all N, the notification controller 44 determines that the level of importance of the edited article for the source article is “low” (S48). If at least one of the determination results at S40, S42, and S46 is Y, the notification controller 44 determines that the level of importance of the edited article for the source article is “high” (S49).

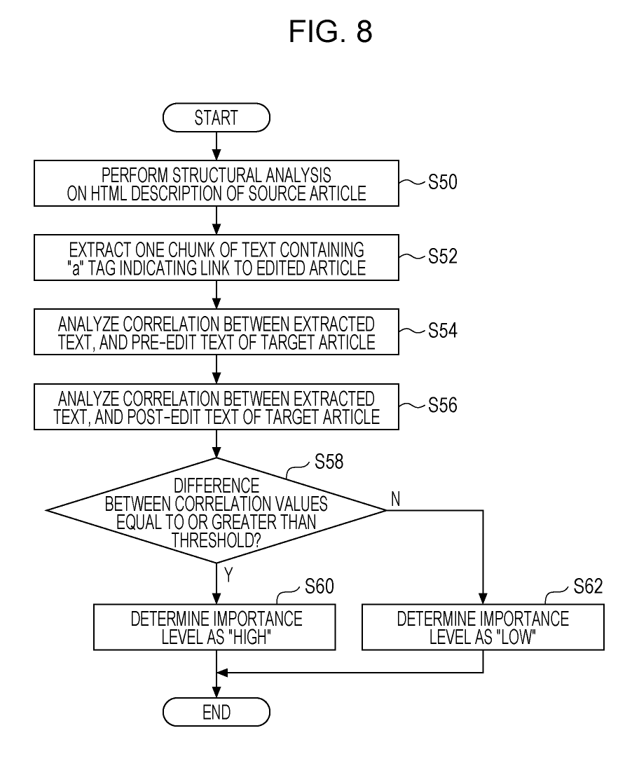

Next, another exemplary detailed procedure for step S28 of the procedure illustrated in FIG. 6 will be described with reference to FIG. 8.

The procedure illustrated in FIG. 8 calculates the level of importance of the edited article (the article corresponding to the ID acquired at S20) for the source article selected at S22 in FIG. 6. According to this procedure, the notification controller 44 performs a structural analysis on the HTML description of the source article (S50), and extracts, from the HTML description, one chunk of text including an “a” tag (anchor tag) element that contains a link to the edited article (to be referred to as “a” element of interest hereinafter) (S52). As such “one chunk” of text, the text within a higher level element (e.g., a “p” element, a “div” element, an “article” element, or a “section” element) that contains the “a” element of interest may be extracted. In this case, the higher level element containing the “a” element of interest may be defined in advance as an element (parent element) one level above the “a” element of interest, or may be defined in advance as an element (e.g., an “article” element or a “section” element) that belongs to one predetermined specific group and is at a higher level the “a” element of interest (may be at a higher level than the parent). In the latter case, a collection of text within one or more elements contained in the higher level element is extracted as one chunk of text at S52. In another possible example, the text spanning from the heading element (represented by a tag such as “h1” or “h2”) immediately preceding the “a” element of interest to the heading element immediately following the “a” element of interest may be extracted as the “one chunk” of text. The rules regarding how to segment text to extract one chunk of text containing the “a” element of interest may be set in the notification controller 44 in advance. Examples of such rules include the following rules: (1) Extract the text within the parent element of the “a” element of interest, (2) Extract the text within an element positioned closest to the “a” element of interest among elements belonging to a specific group at a higher level than the “a” element of interest, and (3) Extract the text between the heading elements immediately preceding and immediately following the “a” element of interest, as well as the rules for determining the priority for applying each of those individual rules.

Next, the notification controller 44 executes a correlation analysis between the text extracted at S52 and the pre-edit text of the edited article (S54), and a correlation analysis between the extracted text and the post-edit text of the edited article (S56). The notification controller 44 then determines whether the absolute value of the difference between the correlation value obtained by the correlation analysis performed at S54 and the correlation value obtained by the correlation analysis performed at S56 is equal to or greater than a given threshold (S58). If the result of this determination is Y, the notification controller 44 determines that the level of importance of the edited article for the source article is “high” (S60), and if the result of this determination is N, the notification controller 44 determines that the importance level is “low” (S62).

If the result of the determination at S58 is Y, this means that the relationship of the edited article to the related portion (the text extracted at S52) of the source article has greatly changed before and after the editing of the edited article. In such a case, it is often necessary to make a correction to the related portion of the source article in accordance with the post-edit contents of the edited article, such as changing its text contents or deleting a link to the edited article (if the editing done has resulted in reduced correlation). Accordingly, in such a case, the notification controller 44 determines the importance level as “high” to ensure that a notification that editing has been performed on the edited article is made to the author of the source article (in a more noticeable manner, that is, in a more easily recognizable manner than is otherwise the case). Conversely, if the result of the determination at S58 is N, this is considered to mean that the relationship of the edited article to the related portion of the source article has changed relatively little before and after the editing, and hence the need to correct the source article is not high. Therefore, the need to notify the author of the source article is not high, either. Accordingly, in this case, the notification controller 44 determines the importance level as “low” so that notification about the editing is provided in a less noticeable manner than for cases in which the importance level is “high”.

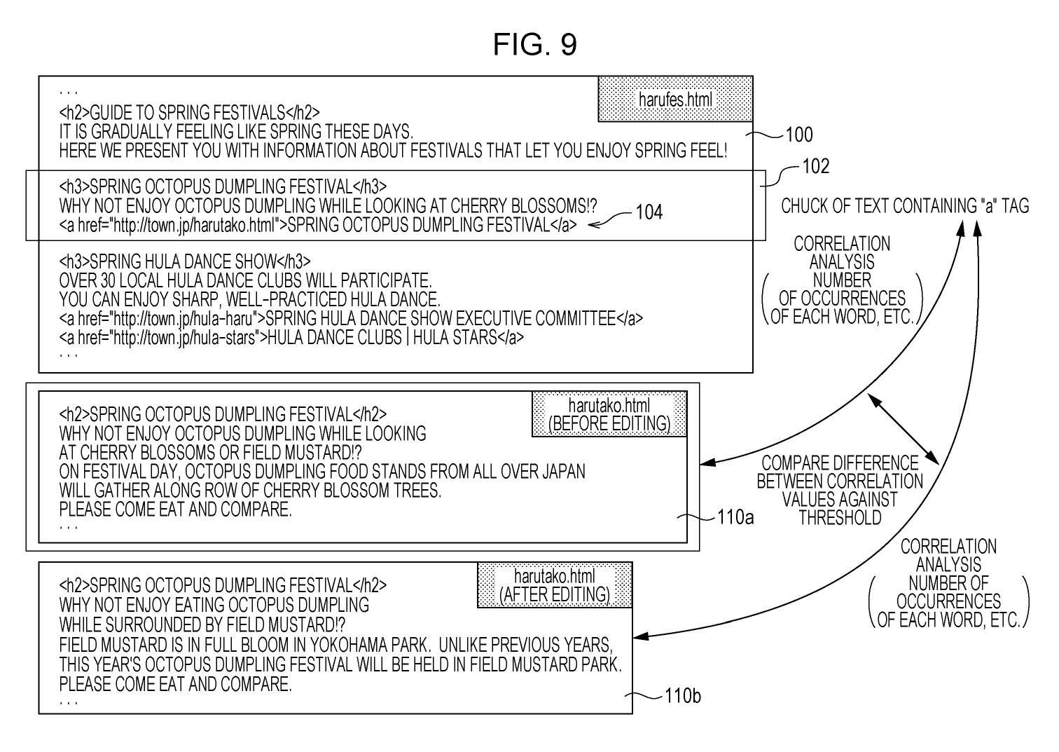

FIG. 9 illustrates an exemplary case in which the procedure illustrated in FIG. 8 is applied to specific articles. This case assumes that an article 110a with an URL “http://town.jp/harutako.html”, which is written in HTML, is edited to become an article 110b. The article 110a or 110b corresponds to the edited article indicated by the article ID acquired at S20 of the procedure illustrated in FIG. 6. An article 100 (URL: “http://town.jp/harufes.html”), which includes an “a” element 104 containing a link to the edited article “http://town.jp/harutako.html”, is the source article that links to the edited article 110a or 110b.

According to the procedure in FIG. 8, at S50, the notification controller 44 analyzes the description of the source article 100, and at S52, the notification controller 44 extracts a chunk 102 of text that includes the “a” element 104. In this example, no higher level element containing the “a” element 104 of interest exists between the heading element “<h3>Spring Octopus Dumpling Festival</h3>” immediately preceding the “a” element 104 and the heading element “<h3>Spring Hula Dance Show</h3>” immediately following the “a” element 104. Thus, the text between the two heading elements is extracted as the chunk 102 of text. Next, at S54 and S56, the notification controller 44 respectively calculates the correlation value between the extracted chunk 102 of text and the pre-edit text of the edited article (the article 110a), and the correlation value between the extracted chunk 102 of text and the post-edit text of the edited article (the article 110b). In the example illustrated in FIG. 9, the difference (absolute value) in correlation value before and after editing is equal to or greater than a threshold. Hence, the importance level is determined as “high”, and notification about the editing performed is provided to the author of the source article 100 in an easily noticeable manner (in comparison to when the importance level is “low”).

In the example described above with reference to each of FIGS. 7 and 8, the importance level takes two values, “high” and “low”. In this regard, the threshold related to importance level used at S30 of the procedure illustrated in FIG. 6 mentioned above is “high”, and if the importance level calculated at S28 is “high”, then the result of determination at S30 is Y.

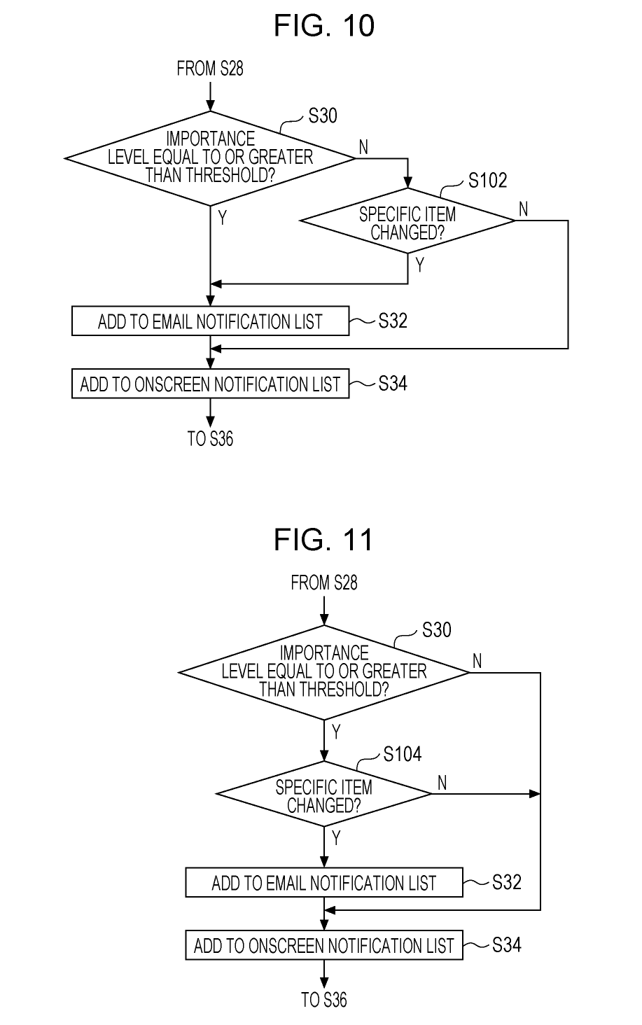

Next, a first modification of the exemplary embodiment mentioned above will be described with reference to FIG. 10. This modification represents a modification of the procedure performed by the edit notification unit 40 illustrated in FIG. 6. FIG. 10 illustrates a portion of the first modification of the procedure performed by the edit notification unit 40 unique to the first modification. Other the portion illustrated in FIG. 10, the procedure according to the first modification may be the same as the procedure illustrated in FIG. 6.

According to the first modification, if the result of determination at S30 is N, the notification controller 44 further determines whether a specific item within the edited article has been changed by the editing performed (S102). A specific item subject to this determination is an item among a group of article's items that, if changed in content, will have a large impact on other articles. For example, if a group of articles within the article DB 10 is for exchanging information within a given local community, a description of a date or place (e.g., the date or venue of a local event) in an article (e.g., an article introducing the event) is an important item for the contents of the article, and thus regarded as a “specific item”. A specific item may be identified by enclosing the item by a specific tag within the HTML description of the article. For example, a specific tag may be either identified by the type of a tag such as a “time” tag, or identified by describing, within a tag indicative of the extent of an element such as a “div” tag or a “span” tag, a predetermined attribute (e.g., a class attribute) indicative of a specific item. Information indicating which tag or attribute corresponds to a “specific item” is set in the notification controller 44, and a specific item within the article is identified in accordance with this setting.

If the result of determination at S102 is Y (i.e., if a specific item has been changed), the procedure proceeds to S32, where the notification controller 44 adds the email address of the author of the source article to the email notification list. If the result of determination at S102 is N, the notification controller 44 executes S34.

As described above, according to the first modification, if editing has been performed on a specific item in the edited article, then email is used as a mode of notification, which is the more noticeable (i.e., more easily recognized by the author of the source article) of the two modes of notification used to notify that the article has been edited, irrespective of the importance level. This ensures that if an edit made to the edited article has resulted in a change to an item that will have a large impact on the source article, the edit is readily recognized by the author of the source article.

Next, a second modification of the exemplary embodiment mentioned above will be described with reference to FIG. 11. The second modification also represents a modification of the procedure performed by the edit notification unit 40 illustrated in FIG. 6. FIG. 11 illustrates a portion of the second modification of the procedure performed by the edit notification unit 40 unique to the second modification. Other the portion illustrated in FIG. 11, the procedure according to the second modification may be the same as the procedure illustrated in FIG. 6.

According to the second modification, if the result of determination at S30 is Y, the notification controller 44 further determines whether a specific item within the edited article has been changed by the editing performed (S104). This specific item may be the same as that according to the first modification mentioned above.

If the result of determination at S104 is Y (i.e., if a specific item has been changed), the procedure proceeds to S32, where the notification controller 44 adds the email address of the author of the source article to the email notification list. If the result of determination at S104 is N, the procedure proceeds to S34, where the notification controller 44 adds the ID of the author of the source article to the onscreen notification list. That is, according to the second modification, even if the importance level is equal to or greater than a threshold, if there is no change to a specific item, then rather than notification by email, notification on the management screen, which is a less noticeable mode of notification than email notification, is used as a mode of notification.

As described above, according to the second modification, notification by email, which is the more noticeable of the two modes of notifications, is employed for cases in which the importance level is equal to or greater than a threshold and editing has been performed on a specific item within the edited article.

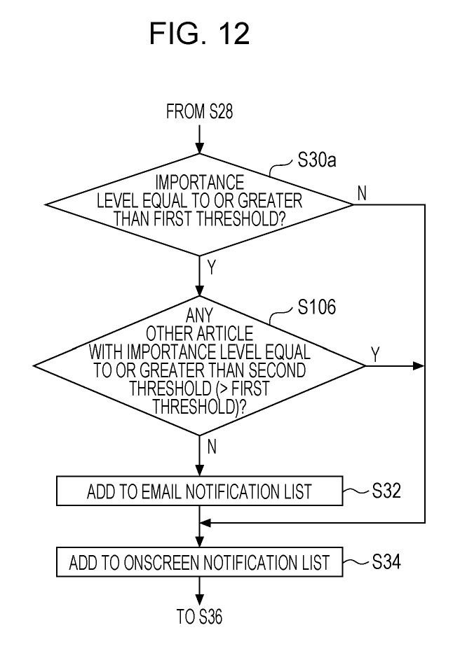

Next, a third modification of the exemplary embodiment mentioned above will be described with reference to FIG. 12. The third modification also represents a modification of the procedure performed by the edit notification unit 40 illustrated in FIG. 6. FIG. 12 illustrates a portion of the third modification of the procedure performed by the edit notification unit 40 unique to the third modification. Other the portion illustrated in FIG. 12, the procedure according to the third modification may be the same as the procedure illustrated in FIG. 6.

According to this procedure, the notification controller 44 determines, after S28 illustrated in FIG. 6 (calculation of importance level), whether the calculated importance level is equal to or greater than a first threshold (S30a). The process performed at S30a is the same as S30 of the procedure illustrated in FIG. 6, and the first threshold used at S30a is equal to the threshold used at S30 in FIG. 6. If the result of determination at S30a is N, the procedure proceeds to S34 as with the procedure illustrated in FIG. 6.

According to the third modification, if the result of determination at S30a is Y, the notification controller 44 determines whether, among other articles edited within a predetermined period of time (e.g. one hour) immediately preceding the edited article, there is any article whose importance level for the corresponding source article (determined at S24 and S26 illustrated in FIG. 6) is equal to or greater than a second threshold (S106). The second threshold, which is greater than the first threshold, is used to detect an edit that is of particular importance (i.e., has a level of importance greatly exceeding the importance indicated by the first threshold) for the source article. If the result of determination at S106 is N, the notification controller 44 selects notification by email as a mode of notification for the author of the source article (S32), and if the result of determination at S106 is Y, the notification controller 44 selects, as a mode of notification, notification to be provided upon login to the management screen (S34). This is in contrast to the procedure illustrated in FIG. 6 in which notification by email (S32) is selected at all times if the importance level is determined at S30 to be equal to or greater than a threshold (=the first threshold).

As described above, according to the third modification, even if the importance level of the edited article for its source article is equal to or greater the first threshold, if there is any article with an importance level equal to or greater the second threshold (to be referred to as high-importance article hereinafter) among other articles edited at substantially the same time (i.e., within a predetermined period of time immediately preceding the time of execution of this procedure), then the notification level is lowered (i.e., notification is made by the management screen) for those articles whose importance level is equal to or greater the first threshold but less than the second threshold, so that a notification of an edit made to a high-importance article becomes comparatively more noticeable to the author of the source article. This makes notification about a high-importance article more easily recognizable by the author of the source article than notification about an article that is important but not as important as the high-importance article. This makes it easier for the author to take appropriate actions in response to editing of the high-importance article, such as correcting the source article that links to the high-importance article.

The third modification may be further modified such that, for example, email notification is selected as a mode of notification for articles whose importance level is equal to or greater the first threshold but less than the second threshold (S32), and a mode of notification even more easily noticeable than email notification is employed as a mode of notification for high-importance articles (whose importance level is equal to or greater the second threshold).

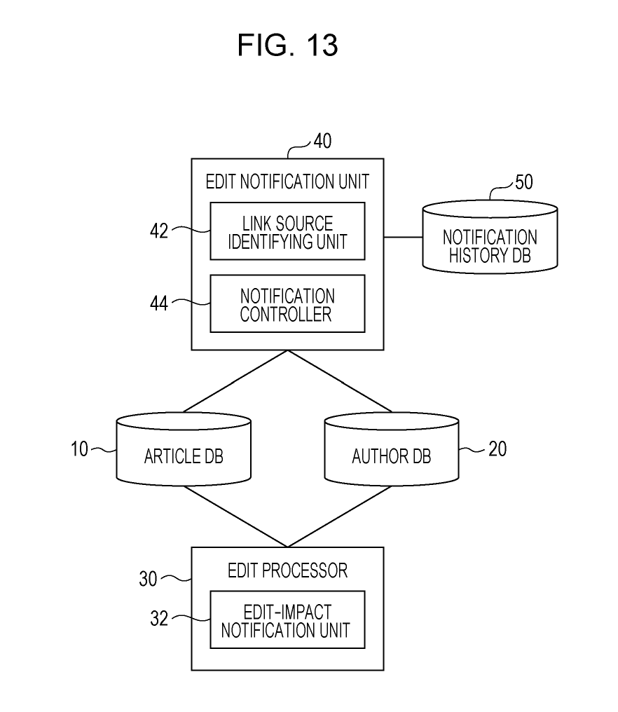

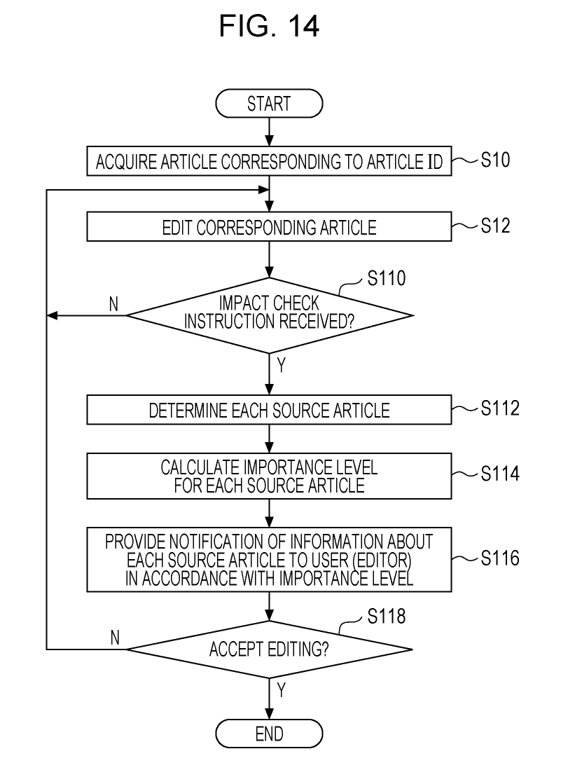

Next, a fourth modification will be described with reference to FIGS. 13 and 14.

FIG. 13 illustrates an exemplary functional configuration of an article editing support apparatus according to the fourth modification. The apparatus according to the fourth modification differs from the apparatus illustrated in FIG. 1 in that the edit processor 30 includes an edit-impact notification unit 32. The edit-impact notification unit 32 provides a user with information indicating how much impact an edit that the user has made to an article by use of the edit processor 30 will have on a source article that links to the article.

FIG. 14 illustrates a portion of the procedure of processing performed by the edit processor 30 according to the fourth modification that is related to the edit-impact notification unit 32. According to this procedure, as with the procedure illustrated in FIG. 5, the edit processor 30 acquires, from the article DB 10, an article corresponding to an article ID specified by the user (editor) (S10), and receives an edit operation on the article performed by the user (S12). Thereafter, in parallel with the execution of steps from S14 onwards in FIG. 5 by the edit processor 30, the edit-impact notification unit 32 executes steps from S110 onwards in FIG. 14.

That is, the edit-impact notification unit 32 waits for an impact check instruction to be input by the user (S110). An impact check instruction is an instruction to check how much impact an edit made by the user to an edited article will have on each source article that links to the edited article. In response to an input of this instruction, the edit-impact notification unit 32 determines, through the same process as S22 to S26 of the procedure illustrated in FIG. 6, each source article that links to the edited article (S112). Next, for each source article determined at S112, the edit-impact notification unit 32 calculates the importance level of the edited article for the source article (S114). As with S28 in FIG. 6, the calculation of importance level at S114 may be performed by the exemplary procedure illustrated in FIG. 7, 8, or other figures. Next, the edit-impact notification unit 32 notifies the user of information about each individual source article thus determined, in accordance with the importance level calculated for each of those source articles (S116). This notification is made by, for example, displaying an edit-impact display field on a screen on which the user is editing the edited article. This edit-impact display field displays each pair of the article ID and article title of a source article in descending order of importance level. In another possible example, only those source articles for which the importance level of the edited article is equal to or greater than a threshold are extracted, and information about each of the extracted source articles (e.g., article ID, title, or an excerpt of the text preceding and following a link to the edited article) is displayed on the screen. When an article ID of a source article displayed in the edit-impact display field is selected by the user by a click or other action, the edit-impact notification unit 32 displays an article corresponding to the article ID on the screen. The source article display field may display an area of the source article that includes a link (such as an “a” tag) to the edited article. By looking at the displayed information, the user checks the contents of the source article (in particular, the portions of the source article preceding and following the link to the edited article), and determines whether to make a further correction with respect to the editing currently done. After looking at the information displayed at S116 and checking the impact of the current editing, if the user determines to accept the current editing done, the user inputs an edit accept (edit complete) instruction. The edit processor 30 waits for an edit accept instruction to be input (S118), and in response to an input of this instruction, the edit processor 30 stores the data of the edited article into the article DB 10. If, based on the information displayed at S116 or other information, the user determines to make a further correction with respect to the editing currently done, the procedure returns to S12.

As described above, according to the fourth modification, the user making an edit to an article is presented with information about each source article on which the edit to the article will have a large impact, and the user uses the information to make determinations such as whether the edit made to the article is appropriate or whether it is necessary to make a correction.

The foregoing description of the exemplary embodiment of the present invention and its modifications is only intended to illustrate one exemplary implementation of the present invention. Various other modifications or alterations are possible within the scope of the present invention.

For example, although the above-mentioned exemplary embodiment uses email as an easily noticeable mode of notification, and uses notification by the management screen as a less noticeable mode of notification, this is only intended to be illustrative. For example, for the same notification to be provided on the management screen, further distinction may be made of its specific mode of notification according to the importance level such that if the importance level is high (equal to or greater than a threshold), the notification is displayed in a lager font size than is otherwise the case, or the notification is displayed in a special notification field specifically used for providing high-importance notification.

According to the above-mentioned exemplary embodiment, the mode of notification (notification by the management screen) used if the importance level is less than a threshold is less noticeable than the mode of notification (email) used if the importance level is equal to or greater than a threshold. In another possible example, no notification is provided if the importance level is less than a threshold.

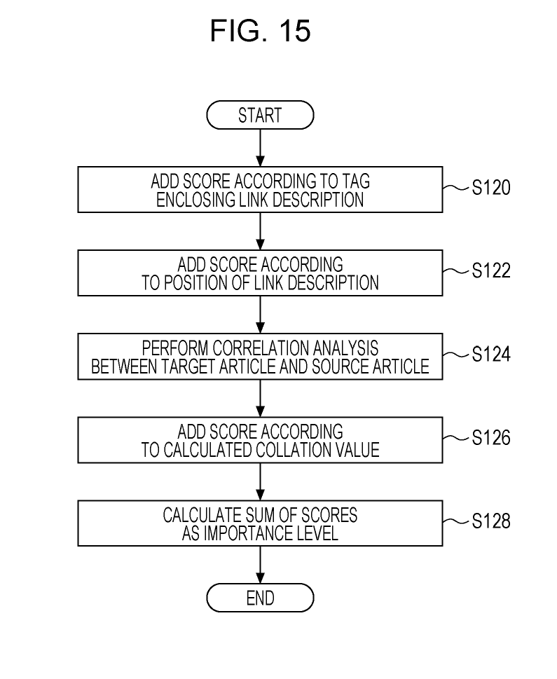

In the foregoing description of the exemplary embodiment and its modifications, the importance level takes two values, high and low. Of course, this is only intended to be illustrative. Instead, the importance level may have three or more values. If importance is to be expressed in multiple levels equal to or greater than three (or as a continuous numerical value), then, for example, the calculation procedure illustrated in FIG. 15 may be used instead of the importance level calculation procedure illustrated in FIG. 7.

In the procedure illustrated in FIG. 15, the notification controller 44 determines each emphasis-related tag within the source article (selected at S22 to S26 in FIG. 6) that encloses a link description pointing to the edited article, and calculates a score according to the tag (S120). This score is related to importance level. The score calculated at S120 is added to a variable (with an initial value of zero) that holds the score of the source article. Examples of emphasis-related tags include heading tags (e.g., an “h1” tag), tags meaning emphasis (an “em” tag), and tags used to provide an emphasis effect by changing typeface (e.g., a “b” tag). A score may be determined in advance for each of those emphasis-related tags. If a link description is enclosed by a tag having an effect opposite to emphasis (e.g., a “small” tag (indicating smaller text size, for example), a “del” tag (indicating deleted text), or an “s” tag (indicating invalid text)), the score may be set to a negative value at S120. In particular, if a link description is enclosed by a tag indicating invalid text, such as a “del” tag or an “s” tag, the final importance level may be regarded as less than a threshold (e.g., zero), irrespective of a score such as one calculated from a different point of view at S122 or S126.

The notification controller 44 calculates a score according to where the link description pointing to the edited article is positioned within the source article, and adds the score to the variable that holds the score of the source article (e.g., the variable holding the score calculated at S120) (S122). At this time, the score according to the position of the link description may be set in advance such that, for example, the score increases with increasing proximity of the link description to the beginning of the source article.

As with S44 in FIG. 7, the notification controller 44 performs a correlation analysis between the edited article and the source article that links to the edited article (S124), and adds a score according to the correlation value obtained by the correlation analysis to the variable that holds the score of the source article (S126). The score according to the value of correlation may be defined in advance as, for example, a function such that the score increases with increasing correlation value.

S120, S122, and S126 may not necessarily be executed in the order illustrated in FIG. 15.

The notification controller 44 then calculates importance level from the sum of the scores obtained at S120, S122, and S126 (S128). The sum of the scores itself may be used as the importance level.

Although the foregoing description of the exemplary embodiment and its modifications is directed to a case in which the environment for editing an article is provided from a server (i.e., the article editing support apparatus, in particular, the edit processor 30 within the article editing support apparatus) to the editor's PC that is a client, this is only intended to be illustrative. An application for providing the article-editing environment may be installed in each individual client PC. In this case, the article editing support apparatus may not have an element corresponding to the edit processor 30. The article-editing application within the PC downloads, from the article DB 10 within the article editing support apparatus, an article specified by the user as the article to be edited, and receives an edit operation on the article performed by the user. When the user completes editing the article, the data of the article that has been edited is transmitted to the article editing support apparatus. The article editing support apparatus registers the received article into the article DB 10 (i.e., updates the contents of the corresponding article within the article DB 10 to the contents of the received article), and also passes the received article (and/or the ID of the article) to the edit notification unit 40 so that the above-mentioned process is executed by the edit notification unit 40.

The article editing support apparatus according to the above-mentioned exemplary embodiment is implemented by causing a computer to execute a program that represents each function of the system described above. In this regard, the computer has a circuit configuration such that, for example, the following hardware components are connected via a bus or other data paths: a microprocessor such as a CPU, memory (internal memory) such as a random-access memory (RAM) and a read-only memory (ROM), a controller that controls a permanent storage such as a flash memory, a solid-state drive (SSD), or a hard disk drive (HDD), various input/output (I/O) interfaces, and a network interface that controls connections to a network such as a local area network. A program describing a process corresponding to each function mentioned above is stored into a permanent storage such as a flash memory via a network or other media, and installed into the computer. The set of exemplary functional modules described above is implemented as the program stored in the permanent storage is read out into the RAM and executed by the microprocessor such as a CPU.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process, the process comprising:
determining a source article that includes a link to an edited article, the edited article being an article subjected to editing; and
controlling notification, the controlling of notification including controlling, in accordance with an importance level of the edited article for the source article, a mode in which a notification about editing performed on the edited article is provided to a user associated with the source article.

2. The non-transitory computer readable medium according to claim 1,
wherein the controlling of notification includes providing the notification to the user in a first notification mode if the importance level is equal to or greater than a threshold, and providing the notification to the user in a second notification mode if the importance level is less than the threshold, the second notification mode being less noticeable than the first notification mode.

3. The non-transitory computer readable medium according to claim 2,
wherein the controlling of notification includes, if editing is performed on a specific item within the edited article, providing the notification in the first notification mode even if the importance level is less than the threshold.

4. The non-transitory computer readable medium according to claim 2,
wherein the controlling of notification includes, if editing is not performed on a specific item within the edited article, providing the notification in the second notification mode even if the importance level is equal to or greater than the threshold value.

5. The non-transitory computer readable medium according to claim 2,
wherein the edited article includes a plurality of edited articles, the plurality of edited articles including
a first article having an importance level equal to or greater than a predetermined second threshold higher than the threshold, and
a second article having an importance level equal to or greater than the threshold and less than the second threshold, and
wherein the controlling of notification includes providing the notification in a less noticeable mode for the second article than for the first article.

6. The non-transitory computer readable medium according to claim 1,
wherein the controlling of notification includes providing the notification to the user if the importance level is equal to or greater than the threshold, and not providing the notification to the user if the importance level is less than the threshold.

7. The non-transitory computer readable medium according to claim 6,
wherein the controlling of notification includes, if editing is performed on a specific item within the edited article, providing the notification even if the importance level is less than the threshold.

8. The non-transitory computer readable medium according to claim 6,
wherein the controlling of notification includes, if editing is not performed on a specific item within the edited article, not providing the notification even if the importance level is equal to or greater than the threshold.

9. The non-transitory computer readable medium according to claim 6,
wherein the edited article includes a plurality of edited articles, the plurality of edited articles including
a first article having an importance level equal to or greater than a predetermined second threshold higher than the threshold, and
a second article having an importance level equal to or greater than the threshold and less than the second threshold, and
wherein the controlling of notification includes not providing the notification for the second article.

10. The non-transitory computer readable medium according to claim 1,
wherein the controlling of notification includes determining the importance level such that the closer a position of the link within the source article is to a beginning of the source article, the higher the importance level.

11. The non-transitory computer readable medium according to claim 1,
wherein the controlling of notification includes, if an emphasis tag is attached to the link in the source article, determining the importance level to be higher than if no emphasis tag is attached to the link.

12. The non-transitory computer readable medium according to claim 1,
wherein the controlling of notification includes determining the importance level such that the higher a correlation in content between the edited article and the source article, the higher the importance level.

13. The non-transitory computer readable medium according to claim 12,
wherein the controlling of notification includes determining, as the correlation, a correlation between a related portion of the source article and the edited article, the related portion being a portion of the source article related to the link.

14. The non-transitory computer readable medium according to claim 1,
wherein the controlling of notification includes determining a correlation between pre-edit contents of the edited article and the source article and a correlation between post-edit contents of the edited article and the source article, and determining the importance level such that the greater a difference between the determined correlations, the higher the importance level.

15. The non-transitory computer readable medium according to claim 14,
wherein the controlling of notification includes determining, as the correlations, a correlation between a related portion of the source article and the pre-edit contents of the edited article and a correlation between the related portion of the source article and the post-edit contents of the edited article, the related portion being a portion of the source article related to the link.

16. The non-transitory computer readable medium according to claim 1,
wherein the process further comprises providing, to a user who has performed editing on the edited article, information about a source article for which the importance level of the edited article is equal to or greater than a second threshold.

17. An article editing support apparatus comprising:
a determination unit that determines a source article that includes a link to an edited article, the edited article being an article subjected to editing; and
a notification controller that, in accordance with an importance level of the edited article for the source article, controls a mode in which a notification about editing performed on the edited article is provided to a user associated with the source article.
